(19) United States
(12) Patent Application Publication
(10) Pub. No.: US 2026/0260003 A1
(43) Pub. Date: Sep. 3, 2026

(54) PRINTER, PROXY MANAGEMENT APPARATUS, AND AUTHENTICATION INFORMATION MANAGEMENT SYSTEM

(71) Applicant: Takanori Fukuhara, Mishima Shizuoka (JP)

(72) Inventor: Takanori Fukuhara, Mishima Shizuoka (JP)

(73) Assignee: ETRIA CO., LTD., Kanagawa (JP)

(21) Appl. No.: 19/267,622

(22) Filed: Jul. 13, 2025

(30) Foreign Application Priority Data
Mar. 3, 2025 (JP) 2025-033211

(51) Int. Cl. G06F 21/60; H04L 9/32

(52) U.S. Cl. CPC G06F 21/608; H04L 9/3226

(57) ABSTRACT

According to embodiments, a printer includes a communication unit, a printing unit, a reader/writer, and a processor. The communication unit communicates with an external apparatus. The printing unit prints an image on a medium including a storage device capable of storing data. The reader/writer writes data in the storage device included in the medium on which the printing unit prints an image. The processor requests a proxy management apparatus connected to the communication unit to manage authentication information for accessing the data written in the storage device by the reader/writer.

### CROSS REFERENCE TO RELATED APPLICATIONS

This application is based upon and claims the benefit of priority from Japanese Patent Application No. 2025-033211, filed Mar. 3, 2025, the entire contents of which are incorporated herein by reference.

### FIELD

Embodiments described herein relate generally to a printer, a proxy management apparatus, and an authentication information management system.

### BACKGROUND

Conventionally, some printers such as label printers have a function of printing an image on a sheet including a storage device such as an RFID tag and writing data in the storage device. In addition, some storage devices such as RFID tags store data protected by authentication information such as an encryption key and a password. Such a storage device prevents “stealing of information”, “impersonation”, and the like, and allows the reader/writer to read data if authentication using an encryption key (key information), a password, or the like set at the time of writing of the data succeeds.

In a case where a conventional printer generates a label including a storage device in which data protected by authentication information is written, the authentication information needs to be managed inside the printer. However, many printers such as conventional label printers do not have a configuration for managing internal data with robust security. In order to enhance the security of data written in the storage device, it is necessary to securely manage authentication information for accessing data held by the storage device. For this reason, a printer that generates a label has a problem that it is necessary to add a function for protecting, with robust security, authentication information for enhancing security of information written in a storage device of the label.

### BRIEF DESCRIPTION OF THE DRAWINGS

FIG. 1 is a diagram illustrating a configuration example of an authentication information management system according to a first embodiment, including a printer and a digital multi-functional peripheral as a proxy management apparatus.

FIG. 2 is a block diagram illustrating a configuration example of the digital multi-functional peripheral as the proxy management apparatus in the authentication information management system according to the first embodiment.

FIG. 3 is a block diagram illustrating a configuration example of a label printer as the printer in the authentication information management system according to the first embodiment.

FIG. 4 is a diagram illustrating a configuration example of a key data management table in the proxy management apparatus in the authentication information management system according to the first embodiment.

FIG. 5 is a flowchart for explaining an operation example of label generation processing by the label printer in the authentication information management system according to the first embodiment.

FIG. 6 is a flowchart for explaining an operation example of key data storage processing by the digital multi-functional peripheral as the proxy management apparatus according to the first embodiment.

FIG. 7 is a flowchart for explaining a first operation example of key data management processing by the digital multi-functional peripheral as the proxy management apparatus according to the first embodiment.

FIG. 8 is a flowchart for explaining a second operation example of the key data management processing by the digital multi-functional peripheral as the proxy management apparatus according to the first embodiment.

FIG. 9 is a diagram illustrating a configuration example (second configuration example) of an authentication information management system according to a second embodiment.

FIG. 10 is a block diagram illustrating a configuration example of a server in the authentication information management system according to the second embodiment.

FIG. 11 is a flowchart for explaining an operation example of processing in which a digital multi-functional peripheral as a proxy management apparatus according to the second embodiment causes the server to store key data.

FIG. 12 is a flowchart for explaining a first operation example of provision processing of providing key data managed by a server as the proxy management apparatus according to the second embodiment.

FIG. 13 is a flowchart for explaining a second operation example of provision processing of providing key data managed by the server as the proxy management apparatus according to the second embodiment.

FIG. 14 is a diagram illustrating a configuration example of an authentication information management system according to a third embodiment.

### DETAILED DESCRIPTION

According to embodiments, a printer includes a communication unit, a printing unit, a reader/writer, and a processor. The communication unit communicates with an external apparatus. The printing unit prints an image on a medium including a storage device capable of storing data. The reader/writer writes data in the storage device included in the medium on which the printing unit prints an image. The processor requests a proxy management apparatus connected to the communication unit to manage authentication information for accessing the data written in the storage device by the reader/writer.

Hereinafter, each of the embodiments will be described with reference to the drawings.

### FIRST EMBODIMENT

First, a configuration of an authentication information management system according to a first embodiment, including a printer and a digital multi-functional peripheral as a proxy management apparatus will be described.

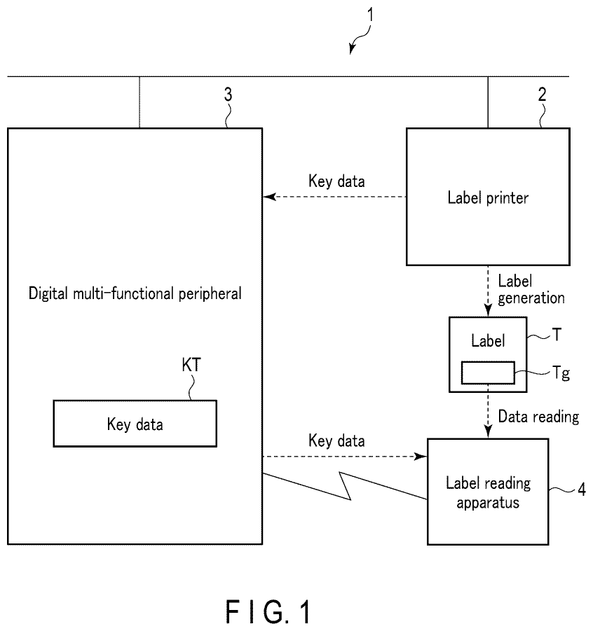

FIG. 1 is a diagram illustrating a configuration example of an authentication information management system according to a first embodiment including a printer and a digital multi-functional peripheral as a proxy management apparatus.

The authentication information management system 1 includes a label printer 2 as the printer that is a label generation apparatus, a digital multi-functional peripheral (MFP) 3, and a label reading apparatus 4.

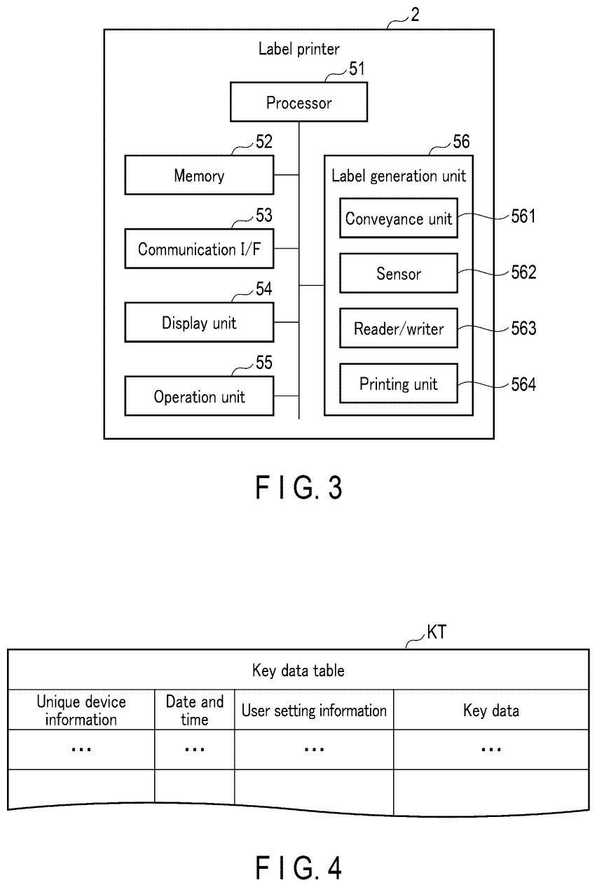

The label printer 2 is an example of the printer in the authentication information management system 1. The label printer 2 as the printer in the authentication information management system 1 includes a label generation unit 56 (see FIG. 3) including a printing unit 564 (see FIG. 3) that prints an image on a print medium (label) T and a reader/writer 563 (see FIG. 3) that writes electronic data in a storage device Tg included in the print medium T.

The storage device Tg included in the label T as the print medium is, for example, an electronic tag such as a radio-frequency identification (RFID) tag. The storage device Tg may be any device provided on the label T and to which data is allowed to be read and written by the reader/writer.

The label printer 2 writes electronic data in the storage device (RFID) Tg included in the label T by the reader/writer 563. The electronic data written in the storage device Tg of the label T by the label printer 2 is information protected by key data as authentication information such as an encryption key or a password. As a result, the label printer 2 can generate the label T including the storage device Tg in which information that cannot be read as normal information without key data is written. In addition, the label printer 2 requests the digital multi-functional peripheral 3 as the proxy management apparatus to manage the key data for reading the information written in the storage device Tg of the generated label T without storing the key data by itself.

That is, in addition to a printing unit that prints an image on the label T, the label printer 2 in the authentication information management system 1 has a function of writing data accessible using the key data (information protected by the key data) in the storage device Tg of the label T and a function of requesting the proxy management apparatus such as the digital multi-functional peripheral 3 to manage the key data.

The digital multi-functional peripheral 3 is an example of an image forming apparatus including the proxy management apparatus. The digital multi-functional peripheral 3 as an image forming apparatus including the proxy management apparatus is installed in a work area or the like. The digital multi-functional peripheral 3 as the proxy management apparatus manages key data as authentication information for reading data written in the storage device Tg of the label T generated by the label printer 2 as the label generation apparatus. The digital multi-functional peripheral 3 as the proxy management apparatus manages key data in response to a request from the label printer 2.

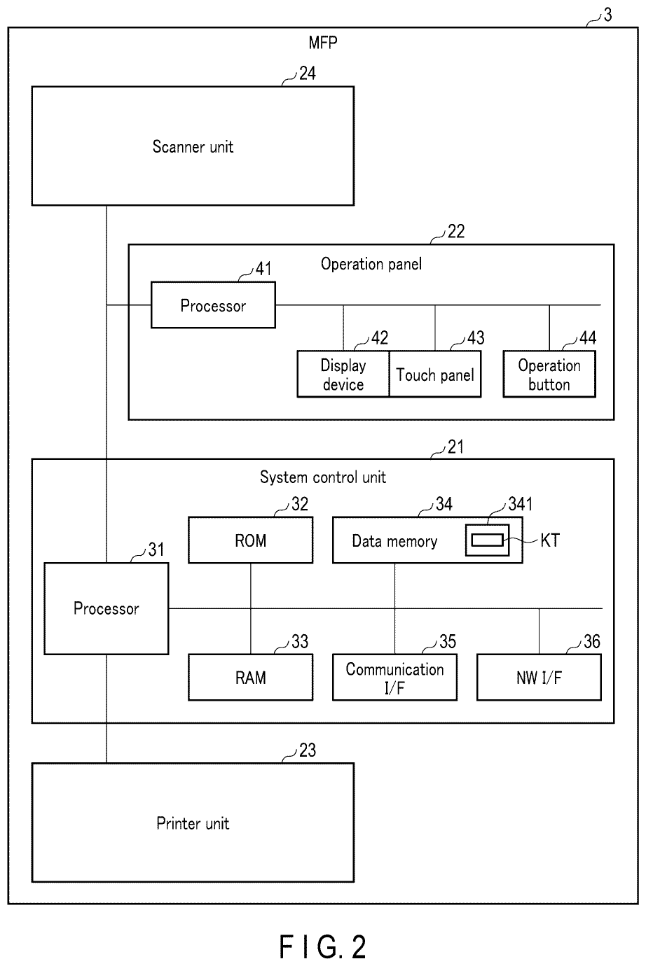

The digital multi-functional peripheral 3 includes a system control unit 21, an operation panel 22, a printer unit 23, a scanner unit 24, and the like (see FIG. 2). In the digital multi-functional peripheral 3 having such a configuration, the system control unit 21 operates as the proxy management apparatus. In the system configuration illustrated in FIG. 1, the digital multi-functional peripheral 3 as the proxy management apparatus has a function of communicating with each label printer 2 as a label generation apparatus and a label reading apparatus that reads stored information of a label.

For example, as the proxy management apparatus, the digital multi-functional peripheral 3 securely stores key data for reading information stored in a label in response to a request from the label printer 2. The digital multi-functional peripheral 3 provides key data or data processed (decrypted) with the key data in response to a request from the label reading apparatus 4 that reads information stored in the storage device Tg of the label T.

The label reading apparatus 4 is an example of an apparatus that reads information written in the storage device Tg of the label T generated by the label printer 2 in the authentication information management system 1. The label reading apparatus 4 includes a display unit, an operation unit, a reader/writer (communication unit) for the storage device Tg, a communication unit with the digital multi-functional peripheral (proxy management apparatus) 3, and the like. The label reading apparatus 4 reads data from the storage device Tg by the reader/writer according to an operation of the operation unit by an operator, and displays a reading result and the like on the display unit. Further, the label reading apparatus 4 communicates with the digital multi-functional peripheral 3 as the proxy management apparatus by the communication unit.

The label reading apparatus 4 in the authentication information management system 1 is, for example, a handy terminal that can be carried by the operator. The handy terminal, which is an example of the label reading apparatus 4, is a portable terminal apparatus including a display unit, an operation unit, a reader/writer, a communication unit, and the like. The handy terminal as the label reading apparatus 4 acquires data written in the storage device Tg of the label T by near field communication with the storage device Tg. The label reading apparatus 4 reads data acquired from the storage device Tg of the label T using key data managed by the digital multi-functional peripheral 3 as the proxy management apparatus.

Next, a configuration of the digital multi-functional peripheral 3 as the image forming apparatus including a license management apparatus according to the embodiment will be described.

FIG. 2 is a block diagram illustrating a configuration example of the digital multi-functional peripheral 3 as an image forming apparatus including the license management apparatus according to the embodiment.

As illustrated in FIG. 2, the digital multi-functional peripheral 3 includes the system control unit (system controller) 21, the operation panel 22, the printer unit 23, and the scanner unit 24.

The system control unit 21 controls the entire digital multi-functional peripheral 3. The system control unit 21 includes a processor 31, a ROM 32, a RAM 33, a data memory 34, a communication interface (I/F) 35, a network (NW) interface (I/F) 36, and the like.

The processor 31 realizes various processing functions by executing a program. The processor 31 is, for example, a CPU. The processor 31 is connected to a processor 41 of the operation panel 22, the printer unit 23, the scanner unit 24, and the like via the internal interface.

The ROM 32 functions as a program memory that stores a program. The ROM 32 is a non-rewritable non-volatile memory. The RAM 33 functions as a working memory or a buffer memory. The processor 31 performs various processing by executing a program stored in the ROM 32 or the data memory 34 using the RAM 33.

The data memory 34 is a rewritable non-volatile memory. For example, the data memory 34 includes a storage apparatus such as a hard disk drive (HDD) or a solid state drive (SSD). The data memory 34 stores various data such as control data, an application program (hereinafter also referred to as application), control data, setting information, and image data.

In addition, the data memory 34 has a storage area 341 for securely storing data. A key data management table KT is provided in the storage area 341 in which data is securely stored. The key data management table KT stores key data as authentication information for accessing data stored in the storage device Tg of the label T generated by the printer 2. For example, the key data management table KT stores key data, in response to a request from each of printers 2, in association with identification information of each printer. The key data stored in the key data management table KT is authentication information such as key information or a password for encryption processing. For example, the key information included in the key data is key information for decrypting the encrypted data written in the storage device Tg of the label T generated by the printer 2 specified by the identification information. The password included in the key data is authentication information for reading data written in the storage device Tg of the label T generated by the printer 2 specified by the identification information.

The communication interface 35 is a communication interface (first communication interface) for performing data communication with each of the label printers 2 subject to functional restriction by a license. The communication interface 35 may include, for example, an interface that communicates with each of the label printers 2 used in the work area by wireless or wired communication.

The NW interface 36 is a communication interface (third communication unit) for communicating with apparatuses connected to the network. In the authentication information management system 1 according to the present embodiment, the NW interface 36 may include an interface for communicating with a server 6 via a network.

The operation panel 22 is a user interface. The operation panel 22 includes the processor 41, a display device 42, a touch panel (operation device) 43, and an operation button (operation device) 44. The display device 42 is a display that displays operation guidance and the like. The touch panel 43 is provided on a display screen of the display device 42. The touch panel 43 detects a part touched by the user on the display screen of the display device 42. The operation button 44 is a button for inputting a predetermined instruction.

The processor 41 of the operation panel 22 controls the operation panel 22. The processor 41 realizes various processing by executing a program stored in an internal memory or an external memory. The processor 41 is connected to the processor 31 of the system control unit 21 and controls the operation panel 22 in response to an instruction from the processor 31 of the system control unit 21. For example, the processor 41 controls display contents to be displayed on the display device 42 in response to an instruction from the processor 31 of the system control unit 21. In addition, the processor 41 detects an input to the touch panel 43 and the operation button 44, and supplies information indicating a content of the input to the processor 31 of the system control unit 21.

The printer unit 23 is an image forming unit included in the digital multi-functional peripheral 3 itself. The printer unit 23 forms an image on a medium (image forming medium) such as paper. For example, the printer unit 23 prints an image for printing supplied from the system control unit 21 on a sheet taken out from a sheet feeding cassette. The printer unit 23 may form an image by any image forming method. For example, the printer unit 23 may print an image on a medium by an electrophotographic method or may print an image on a medium by an inkjet method.

The scanner unit 24 is an apparatus that reads an image of a document. The scanner unit 24 is installed, for example, in an upper portion of a main body of the digital multi-functional peripheral 3. The scanner unit 24 optically reads an image of a document set on a scanner bed glass or a document set in an auto document feeder (ADF). The scanner unit 24 outputs image data of the document as a result of reading the image of the document.

Next, a configuration of the label printer 2 in the authentication information management system 1 according to the embodiment will be described.

FIG. 3 is a block diagram illustrating a configuration example of the label printer 2 in the authentication information management system 1 according to the embodiment.

As illustrated in FIG. 3, the label printer 2 includes a processor (second processor) 51, a memory 52, a communication interface (I/F) 53, a display unit 54, an operation unit 55, a label generation unit 56, and the like.

The processor 51 executes a program for executing various processing. The processor 51 is, for example, a CPU. The processor 51 is connected to each unit in the label printer 2 via an internal interface. The processor 51 executes various processing by executing a program stored in the memory 52.

The memory 52 includes a ROM, a RAM, a data memory, and the like. The ROM of the memory 52 is a non-rewritable non-volatile memory, and stores a preset program, control data, and the like. The RAM of the memory 52 functions as a working memory or a buffer memory. The data memory of the memory 52 is a rewritable non-volatile memory, and stores data such as a program, control data, and setting information. In addition, the data memory of the memory 52 may store device authentication information and the like set for the digital multi-functional peripheral 3 and the proxy management apparatus.

The communication interface 53 is a communication interface (communication unit, first communication unit) for communicating with the digital multi-functional peripheral 3. The communication interface 53 may include an interface of a communication method compatible with the communication interface included in the digital multi-functional peripheral 3.

The display unit 54 is a display that displays operation guidance and the like. For example, the display unit 54 includes a liquid crystal display apparatus, an organic EL, or the like. The operation unit 55 accepts an operation by a user. For example, the operation unit 55 includes a group of buttons pressed by the user. Furthermore, the operation unit 55 may include a touch panel provided on the display screen of the display unit 54.

The label generation unit 56 generates a label by printing an image on the medium T as a label and writing data in the storage device Tg of the medium T. In the configuration example illustrated in FIG. 3, the label generation unit 56 includes a conveyance unit 561, a sensor 562, the reader/writer 563, the printing unit 564, and the like.

The conveyance unit 561 transfers a medium (paper) T as a label along a predetermined conveyance path. The conveyance unit 561 feeds a medium (paper) T including the storage device Tg to be generated as a label, and supplies the medium T to the reader/writer 563 and the printing unit 564. The sensor 562 detects presence or absence of the medium T at a predetermined position or the like serving as a conveyance path of the medium T as a label.

The reader/writer 563 writes data in the storage device Tg included in the medium T as a label transferred along the conveyance path. The reader/writer 563 includes a reader/writer apparatus compatible with the storage device Tg included in the medium T as a label. The storage device included in the medium T as a label is an electronic device such as an RFID. For example, in a case where the storage device Tg is an RFID, the reader/writer 563 includes a communication unit that performs short-range wireless communication conforming to specifications of the RFID, and writes data in the storage device Tg by supplying a write command to the RFID by the short-range wireless communication.

The printing unit 564 prints an image (forms an image) on a print surface of the label T as the print medium. For example, the printing unit 564 includes a thermal printing mechanism having a print head such as a thermal head. In a case where the printing unit 564 includes the thermal printing mechanism, the printing unit prints an image on the print surface of the medium T by driving and controlling a plurality of heat generating elements provided for the thermal head according to an image to be printed. However, the printing unit 564 may include a printing mechanism that prints an image by an image forming method, other than a thermal method, such as an inkjet method.

Next, the configuration of the key data management table KT included in the digital multi-functional peripheral 3 as the proxy management apparatus according to the first embodiment will be described.

FIG. 4 is a diagram illustrating a configuration example of a key data management table KT included in the digital multi-functional peripheral 3 as the proxy management apparatus according to the first embodiment.

The key data management table KT is securely stored in a memory such as the data memory 34 of the digital multi-functional peripheral 3 as the proxy management apparatus. For example, the key data management table KT is provided in the storage area 341 for securely storing data in the data memory 34.

In the configuration example illustrated in FIG. 4, the key data management table KT stores information such as unique device information, registration date and time, user setting information, and key data in association with each other.

The unique device information is an example of the identification information for identifying the key data. The unique device information is identification information of the label printer 2 that is a request source of proxy management of key data. That is, the unique device information is identification information of the label printer 2 in which data that can be accessed (read) using the key data is written in the storage device Tg of the label T. Here, the unique device information may be information, or the like, indicating a MAC address of the label printer 2 that is the request source of the proxy management of the key data.

As the date and time, the date and time, and the like, when a request for proxy management of key data is received from the label printer 2 are stored. As the user setting information, information set by the user is stored. For example, the user setting information may be a machine name or the like set by the user to the label printer 2 that has requested proxy management of key data.

The key data is authentication information for accessing data stored in the storage device Tg of the label T generated by the label printer 2. The key data as the authentication information is information such as key information or a password used for encryption process. For example, the key information as the key data is key information (key information for decryption) for decrypting the encrypted data written in the storage device Tg of the label T generated by the label printer 2 specified by the identification information. The password as key data is authentication information for allowing access to data written in the storage device Tg of the label T generated by the label printer 2 specified by the identification information.

Next, label generation processing including a request for proxy management of key data to the proxy management apparatus by the label printer 2 as the printer according to the first embodiment will be described.

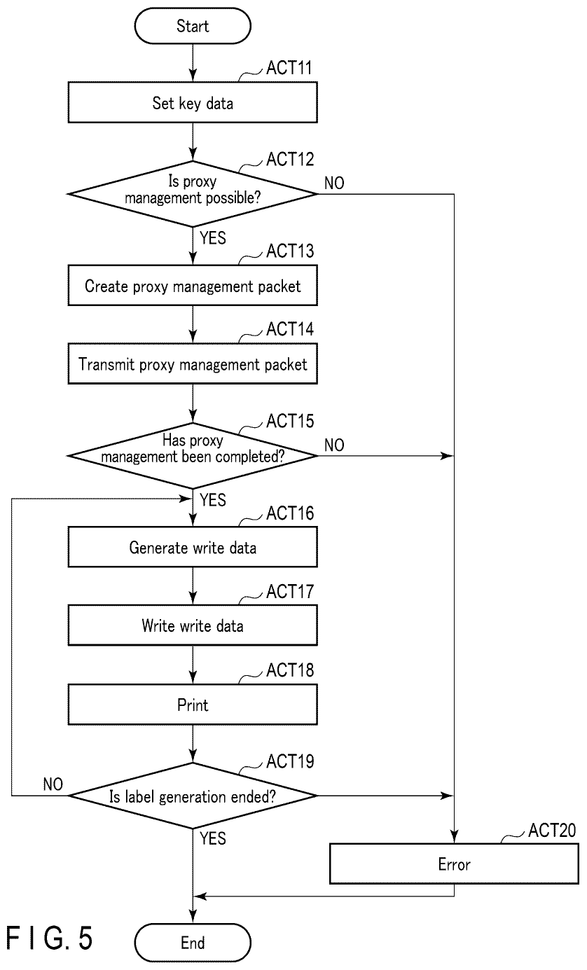

FIG. 5 is a flowchart for explaining the label generation processing including a request for proxy management of key data by the label printer 2 as the printer according to the first embodiment. It is assumed that the label printer 2 executes processing (label generating processing) of printing a label image on the medium T including the storage device (RFID tag) Tg and generating a label in which information protected by key data is written in the storage device Tg.

The processor 51 of the label printer 2 acquires an image (label image) to be printed on the print surface of the label T and information (label information) to be recorded in the storage device Tg of the label T, together with a command for instructing generation of a label. Here, it is assumed that the processor 51 writes label information as information to be recorded in the storage device Tg of the label T in the storage device Tg in a state in which the label information is protected by key data subjected to proxy management by the digital multi-functional peripheral 3.

The processor 51 of the label printer 2 sets key data as authentication information for protecting the label information to be recorded in the storage device Tg of the label T (ACT 11). In the present embodiment, key data is set for each of the label printers 2. However, the key data may be set for each label to be generated, or may be set for each group of labels. For example, the key data may be set for each group of labels generated by a series of label generating processing.

Upon setting of the key data, the processor 51 of the label printer 2 determines whether the proxy management of the key data is possible in the authentication information management system 1 including the label printer 2 (ACT 12). For example, the processor 51 of the label printer 2 determines whether the proxy management is possible depending on whether communication with the digital multi-functional peripheral 3 capable of performing proxy management of key data is possible in the authentication information management system 1.

In addition, the label printer 2 may store, in the memory 52, information (authentication device information) indicating the digital multi-functional peripheral (proxy management apparatus) 3 capable of performing proxy management of key data. In this case, the processor 51 determines whether or not the proxy management of the key data is possible depending on whether or not the digital multi-functional peripheral 3 as the proxy management apparatus specified by the authentication device information can communicate via the communication interface 53. In addition, the processor 51 may perform mutual authentication with the digital multi-functional peripheral 3 communicating via the communication interface 53, and determine whether or not the digital multi-functional peripheral 3 that has succeeded in the mutual authentication can perform proxy management of key data.

In a case where there is no proxy management apparatus capable of performing the proxy management of the key data, or in a case where the mutual authentication with the digital multi-functional peripheral 3 as the proxy management apparatus fails, the processor 51 of the label printer 2 determines that the proxy management of the key data is not possible. In a case where it is determined that the proxy management of the key data is not possible (ACT 12, NO), the processor 51 stops the generation of the label as an error (ACT 20).

In a case where it is determined that the proxy management of the key data is possible (ACT 12, NO), the processor 51 of the label printer 2 creates a proxy management packet (token) requesting the proxy management of the key data (ACT 13). The processor 51 creates a dedicated proxy management packet including data necessary for proxy management of key data by the digital multi-functional peripheral 3 as the proxy management apparatus. For example, the processor 51 creates a proxy management packet in which a dedicated header corresponding to the digital multi-functional peripheral 3 serving as the proxy management apparatus is added to data including identification information of the label printer 2 and key data as a target of the proxy management.

Upon creation of the proxy management packet, the processor 51 of the label printer 2 transmits the created proxy management packet to the digital multi-functional peripheral 3 as the proxy management apparatus (ACT 14). Upon transmission of the proxy management packet, the processor 51 waits for a response from the digital multi-functional peripheral 3 (ACT 15). In a case where the processor 51 receives a notification indicating that proxy management of the key data is impossible from the digital multi-functional peripheral 3 in response to the proxy management packet (ACT 15, NO), the processor stops generation of the label as error processing (ACT 20).

In a case where the processor 51 of the label printer 2 receives a notification indicating that the proxy management of the key data has been completed from the digital multi-functional peripheral 3 in response to the proxy management packet (ACT 15, YES), the processor starts generating the label T using the key data that has been managed by the digital multi-functional peripheral 3 as a proxy.

In a case where the label T using the key data is generated, the processor 51 of the label printer 2 generates write data to be actually written to the storage device Tg (ACT 16). The write data to the storage device Tg is data obtained by protecting label information to be recorded in the storage device Tg with key data, and is data that can be accessed using the key data.

For example, in a case where the digital multi-functional peripheral 3 is caused to perform proxy management of key information for decryption as key data, the processor 51 of the label printer 2 generates encrypted data in which the label information is encrypted that can be decrypted with the key information included in the key data. Specifically, the label printer 2 holds key information for encryption paired with key information for decryption included in the key data in the memory 52. The processor 51 generates, as the write data, data (encrypted data) obtained by encrypting label information to be recorded in the storage device Tg using key information for encryption. In addition, in a case where a password as key data is subjected to proxy management, the processor 51 generates write data set to be accessible (readable) in a case where authentication by the password is successful.

Upon generation of the write data, the processor 51 of the label printer 2 writes the write data and the identification information (unique device information) of the label printer 2 to the storage device Tg of the medium T by the reader/writer 563 (ACT 17). For example, the processor 51 causes the conveyance unit 561 to transfer the medium T including the storage device Tg in an initial state (unprinted state) to a position for data writing by the reader/writer 563. The reader/writer 563 writes the write data generated by the processor 51 and the unique device information to the storage device Tg of the medium T transferred to the position for data writing.

Upon completion of the data writing to the storage device Tg of the medium T, the processor 51 of the label printer 2 prints a label image on the print surface of the medium T by the printing unit 564 (ACT 18). For example, the processor 51 causes the conveyance unit 561 to transfer the medium T in which writing of the data to the storage device Tg has been completed to a position for printing by the printing unit 564. The printing unit 564 prints the label image supplied from the processor 51 on the print surface of the medium T transferred to the position for printing.

Upon completion of the printing on the print surface of the medium T, the processor 51 of the label printer 2 ends the generation of one label. The processor 51 determines whether or not to end a series of label generation processing each time generation of one label ends (ACT 19). For example, in a case where generation of the next label using the concerned key data is continuously executed (ACT 19, NO), the processor 51 returns the processing to ACT 16 and generates the next label by the above-described operation. In a case where it is determined that the series of label generation processing is to be ended (ACT 19, YES), the processor 51 ends the label generation processing.

According to the above processing, the printer requests the proxy management apparatus to manage the authentication information for accessing the data to be written in the storage device of the label, and generates the label including the storage device in which the information accessible by the authentication information managed by the proxy management apparatus is written. As a result, since the printer does not need to store or manage the authentication information for accessing the data written in the storage device of the label by itself, it is not necessary to include a configuration for securely storing the authentication information. In addition, since the printer can request the digital multi-functional peripheral having the function of securely storing the authentication information to manage the authentication information, a system that can safely store the authentication information as the entire authentication information management system can be constructed at low cost.

Next, key data storage processing by the digital multi-functional peripheral 3 as the proxy management apparatus according to the first embodiment will be described.

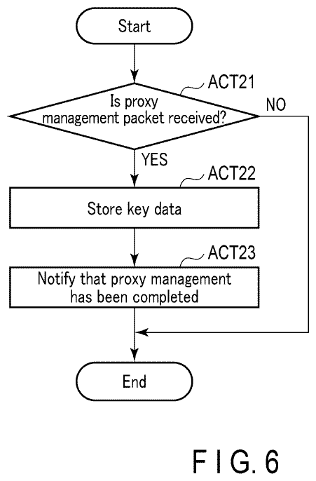

FIG. 6 is a flowchart for explaining an operation example of key data storage processing by the digital multi-functional peripheral 3 as the proxy management apparatus according to the first embodiment.

The digital multi-functional peripheral 3 as the proxy management apparatus executes storage processing of key data as the authentication information in response to the request by the proxy management packet from the label printer 2 as described above. The processor 31 of the digital multi-functional peripheral 3 accepts the proxy management packet from the label printer 2 that is the request source of the proxy management of the key data (ACT 21).

For example, the digital multi-functional peripheral 3 functioning as the proxy management apparatus stores, in the data memory 34, information (authentication device information) indicating the label printer 2 capable of accepting the request for the proxy management of the key data. In this case, the processor 31 of the digital multi-functional peripheral 3 accepts the request for the proxy management of the key data by the proxy management packet from the label printer (or a label printer conforming to the authentication device information) 2 indicated by the registered authentication device information. In addition, the processor 31 of the digital multi-functional peripheral 3 may perform mutual authentication with the label printer 2 that communicates via the communication interface 35, and may accept the proxy management packet from the label printer 2 for which the mutual authentication has succeeded.

In a case where the proxy management packet has been received from the label printer 2 (ACT 21, YES), the processor 31 of the digital multi-functional peripheral 3 stores data such as key data for which the proxy management has been requested (ACT 22). For example, the processor 31 stores data such as key data for which the proxy management is requested by the proxy management packet from the label printer 2 in the key data management table KT provided in the secure storage area 341 in the data memory 34.

For example, the processor 31 of the digital multi-functional peripheral 3 acquires key data to be subjected to proxy management and identification information (unique device information) of the label printer 2 from the proxy management packet received from the label printer 2. The processor 31 stores, in the key data management table KT, the key data for which the proxy management is requested by the proxy management packet in association with the unique device information as the identification information of the label printer. In addition, the processor 31 acquires not only the key data but also information such as date and time and user setting information based on the proxy management packet, and stores the information in the key data management table KT in association with the unique device information.

Upon completion of the storage of the information such as the key data for which the proxy management has been requested in the key data management table KT, the processor 31 of the digital multi-functional peripheral transmits a notification indicating that the proxy management has been completed to the label printer 2 (ACT 23). For example, the processor 31 transmits, in response to the proxy management packet, the notification indicating that the proxy management has been completed to the label printer 2 that is a transmission source of the proxy management packet.

According to the above processing, a digital multi-functional peripheral as the proxy management apparatus can store key data as the authentication information in association with unique device information of the printer according to a proxy management packet from a label printer. In addition, it is possible to store key data as the authentication information for accessing information to be recorded in a storage device of the label in the digital multi-functional peripheral having a more robust security function than the label printer. As a result, information to be recorded in the storage device of the label can be safely protected, and unauthorized access to the data written in the storage device can be prevented. In addition, since the digital multi-functional peripheral already having a robust security function is caused to perform proxy management of key data, the above-described authentication information management system can be easily and inexpensively constructed.

Next, management and provision of key data by the digital multi-functional peripheral 3 as the proxy management apparatus according to the first embodiment will be described.

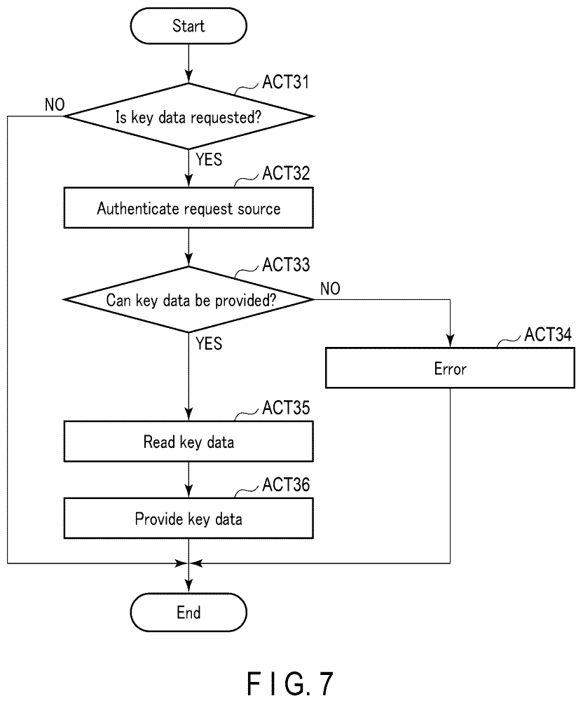

FIG. 7 is a flowchart for explaining a first operation example of key data management processing by the digital multi-functional peripheral 3 as the proxy management apparatus according to the first embodiment.

The digital multi-functional peripheral 3 as the proxy management apparatus has a function of providing key data stored in the key data management table KT in response to a request from the label reading apparatus 4. The processor 31 of the digital multi-functional peripheral 3 accepts a provision request for providing key data from the label reading apparatus 4 that reads information from the storage device Tg of the label T (ACT 31).

For example, data (label information) protected by key data and identification information (unique device information) of the label printer 2 that has generated the label T are written in the storage device Tg of the label T. The label reading apparatus 4 wirelessly communicates with the storage device Tg of the label T and transmits a read command to the storage device Tg. The storage device Tg of the label T transmits the data protected by the key data and the unique device information in response to the read command from the label reading apparatus 4. As a result, the label reading apparatus 4 acquires the data protected by the key data and the unique device information which is the identification information of the label printer 2 from the storage device Tg of the label T.

Upon acquisition of the data protected by the key data from the storage device Tg, the label reading apparatus 4 requests the digital multi-functional peripheral 3 for the key data. For example, in order to access the data protected by the key data (in order to read the write data in the storage device Tg), the label reading apparatus 4 requests key data from the digital multi-functional peripheral 3 by specifying unique device information acquired from the storage device Tg.

In a case where the key data request is received from the label reading apparatus 4 (ACT 31, YES), the processor 31 of the digital multi-functional peripheral 3 performs processing of authentication that the label reading apparatus 4 is an apparatus that can provide key data (ACT 32). For example, the digital multi-functional peripheral 3 stores, in the data memory 34, information (authentication device information) indicating the label reading apparatus 4 that can provide the key data subjected to proxy management. In this case, the processor 31 determines whether or not the label reading apparatus 4 that is a request source of the key data is an apparatus that can provide the key data based on the authentication device information set in advance. In addition, the processor 31 may authenticate the label reading apparatus 4 as an apparatus capable of providing key data by mutual authentication with the label reading apparatus 4.

Further, the digital multi-functional peripheral 3 may authenticate the label reading apparatus 4 as an apparatus capable of providing key data by a code image (two-dimensional barcode) displayed on the display device 42. In this case, the label reading apparatus 4 includes a scanner capable of reading a code image. For example, the processor 31 of the digital multi-functional peripheral 3 displays, on the display device 42, a code image (two-dimensional barcode) indicating information for allowing provision of the key data. The label reading apparatus 4 reads a code image that the digital multi-functional peripheral 3 displays on the display device 42, and accesses the digital multi-functional peripheral 3 by information read from the code image. The processor 31 of the digital multi-functional peripheral 3 may authenticate the label reading apparatus 4 that has accessed using the information indicating the code image as an apparatus that can provide key data.

In a case where the label reading apparatus 4 that is the request source of the key data cannot be authenticated as an apparatus that can provide the key data (ACT 32, YES), the processor 31 of the digital multi-functional peripheral 3 stops providing the key data as error processing (ACT 34).

In a case where the processor 31 of the digital multi-functional peripheral 3 has been able to authenticate the label reading apparatus 4 that is the request source of the key data as an apparatus capable of providing the key data (ACT 32, YES), the processor allows the provision of the key data to the label reading apparatus 4. Upon allowance of the provision of the key data, the processor 31 reads the key data corresponding to the identification information (unique device information) of the label printer specified by the label reading apparatus 4 from the key data management table KT (ACT 35). Upon reading of the key data corresponding to the specified unique device information from the key data management table KT, the processor 31 provides the key data read from the key data management table KT to the label reading apparatus 4 as the request source (ACT 36).

As a result, the label reading apparatus 4 can acquire the key data to be managed by the digital multi-functional peripheral 3 as the proxy management apparatus in place of the label printer 2 that has generated the label T. The label reading apparatus 4 can read information written in the storage device Tg of the label T using the key data acquired from the digital multi-functional peripheral 3.

For example, in a case where the key data is key information for decryption, encrypted data to be decrypted with the key data is written as data protected with the key data in the storage device Tg of the label T. In this case, the label reading apparatus 4 decrypts the encrypted data using key information for decryption acquired as key data from the digital multi-functional peripheral 3. The label reading apparatus 4 presents information read from the storage device Tg of the label T to the operator by displaying the data decrypted using the key data on the display unit.

In a case where the key data is a password, data for which the password is set as the data protected by the key data is written in the storage device Tg of the label T. In this case, the label reading apparatus 4 reads information written in the storage device Tg if a password input by the operator matches the password acquired as the key data from the digital multi-functional peripheral 3. The label reading apparatus 4 presents information read from the storage device Tg of the label T by successful authentication with a password to the operator by displaying the information on the display unit.

Next, a second operation example of key data management processing by the digital multi-functional peripheral 3 as the proxy management apparatus according to the first embodiment will be described.

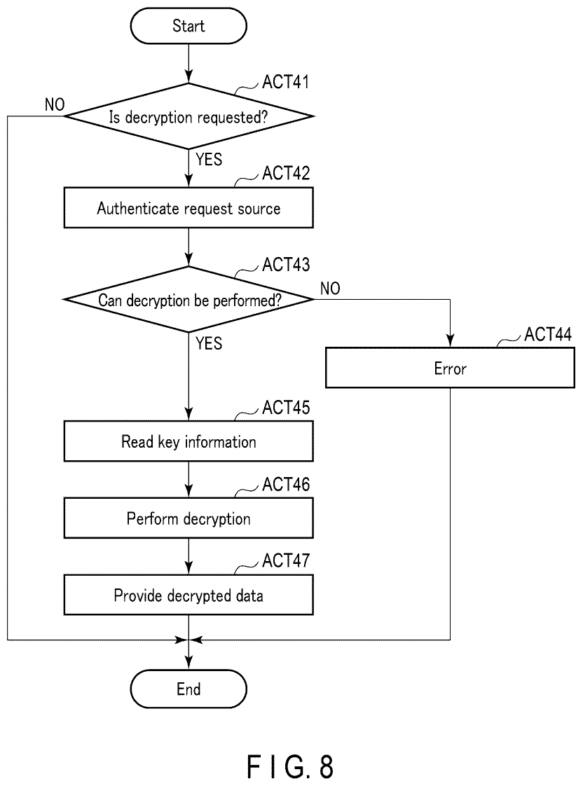

FIG. 8 is a flowchart for explaining the second operation example of the key data management processing by the digital multi-functional peripheral 3 as the proxy management apparatus according to the first embodiment.

In the first operation example, the digital multi-functional peripheral 3 as the proxy management apparatus transmits (provides) the key data in response to a request from the label reading apparatus 4. On the other hand, in the second operation example, the digital multi-functional peripheral 3 as the proxy management apparatus provides (transmits) data in which data protected by key data is made readable to the label reading apparatus 4.

In the second operation example, it is assumed that encrypted data that can be decrypted with key data is written as data protected with the key data in the storage device Tg of the label T. The label reading apparatus 4 wirelessly communicates with the storage device Tg of the label T and transmits a read command to the storage device Tg. The storage device Tg of the label T transmits encrypted data as data protected by key data and identification information (unique device information) of the label printer 2 in response to a read command from the label reading apparatus 4. As a result, the label reading apparatus 4 acquires the encrypted data and the unique device information which is the identification information of the label printer 2 from the storage device Tg of the label T. The label reading apparatus 4 specifies the unique device information acquired from the storage device Tg and demands (requests) the digital multi-functional peripheral 3 to decrypt the encrypted data.

The processor 31 of the digital multi-functional peripheral 3 communicates with the label reading apparatus 4 through a communication unit such as the communication interface 35 or the network interface 36. The processor 31 accepts a decryption request of the encrypted data that the label reading apparatus 4 communicating via the communication unit has read from the storage device Tg of the label T (ACT 41).

In a case where the decryption request of the encrypted data is received from the label reading apparatus 4 (ACT 41, YES), the processor 31 of the digital multi-functional peripheral 3 performs a processing of authentication that the label reading apparatus 4 is a device capable of providing decryption processing of the encrypted data (ACT 42).

For example, the digital multi-functional peripheral 3 stores, in the data memory 34, information (authentication device information) indicating the label reading apparatus 4 that can provide decryption processing of data using the key data subjected to proxy management. In this case, the processor 31 determines whether or not the label reading apparatus 4 as a source of the decryption request is an apparatus capable of providing decryption processing of data based on the authentication device information set in advance. In addition, the processor 31 may authenticate the label reading apparatus 4 as an apparatus capable of providing decryption processing of data by mutual authentication with the label reading apparatus 4.

Further, the digital multi-functional peripheral 3 may authenticate the label reading apparatus 4 as an apparatus capable of providing decryption processing of data by a code image (two-dimensional barcode) displayed on the display device 42. In this case, the label reading apparatus 4 includes a scanner capable of reading a code image. For example, the processor 31 of the digital multi-functional peripheral 3 displays, on the display device 42, a code image (two-dimensional barcode) indicating information for allowing provision of the decryption processing of data. The label reading apparatus 4 reads a code image that the digital multi-functional peripheral 3 displays on the display device 42, and accesses the digital multi-functional peripheral 3 by information read from the code image. The processor 31 of the digital multi-functional peripheral 3 may authenticate the label reading apparatus 4 accessed by the information indicating the code image as an apparatus that can provide decryption processing of data.

The processor 31 of the digital multi-functional peripheral 3 determines whether or not to allow provision of the decryption processing for the encrypted data depending on whether or not the label reading apparatus 4 as the source of the decryption request has been authenticated (ACT 43).

In a case where the processor 31 cannot provide the decryption processing of the encrypted data (ACT 43, NO), the processor performs error processing and ends the processing (ACT 44).

In a case where the provision of the decryption processing of the encrypted data is allowed (ACT 43, YES), the processor 31 reads, from the key data management table KT, the key information for decryption as the key data corresponding to the unique device information specified by the label reading apparatus 4 (ACT 45). The processor 31 decrypts the encrypted data acquired from the label reading apparatus 4 using the key information for decryption as the key data read from the key data management table KT (ACT 46). Upon decryption of the encrypted data with the key information for decryption as the key data, the processor 31 provides the decrypted data to the label reading apparatus 4 (ACT 47).

As a result, the label reading apparatus 4 can acquire data obtained by decrypting the encrypted data acquired from the storage device by the digital multi-functional peripheral 3 as the proxy management apparatus. That is, the label reading apparatus can acquire the decrypted data without acquiring a decryption key for the encrypted data written in the storage device Tg or executing the decryption processing. As a result, the label reading apparatus can read the encrypted data in the storage device without performing complicated calculation such as encryption processing. In addition, as the entire authentication information management system, the encrypted data is read by the label reading apparatus without outputting the key data outside the proxy management apparatus, and the effect of preventing leakage of the key data and the like is high, and robust security can be provided.

### SECOND EMBODIMENT

Next, an authentication information management system 1 according to a second embodiment will be described.

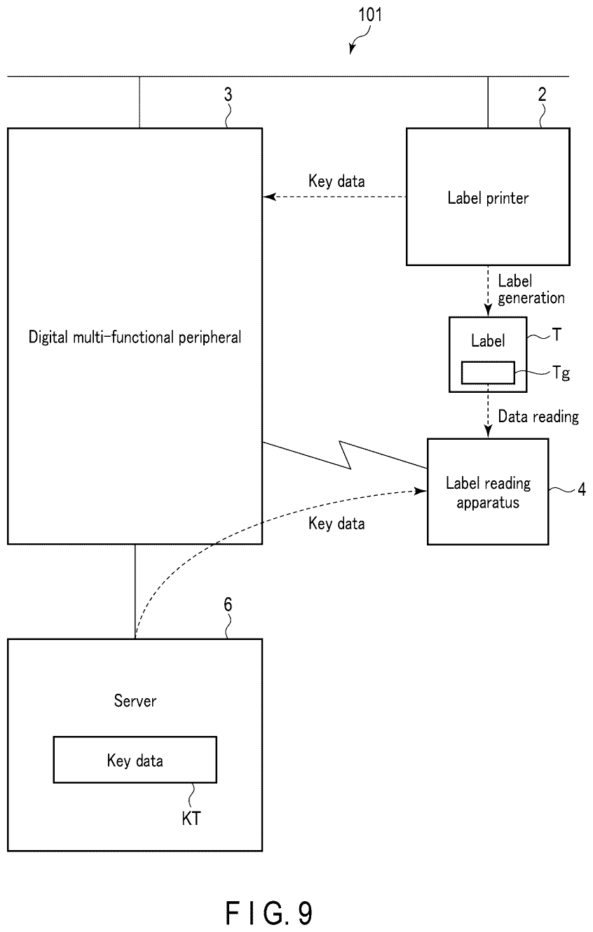

FIG. 9 is a diagram illustrating a configuration example (second configuration example) of the authentication information management system 1 according to the second embodiment.

In the second configuration example illustrated in FIG. 9, the authentication information management system 1 includes a server 6 capable of communicating with a digital multi-functional peripheral 3, in addition to the configuration illustrated in FIG. 1, and the server 6 includes a key data management table KT and has a function as a proxy management apparatus that manages key data.

The authentication information management system 1 according to the second embodiment has a configuration in which the server 6 as a proxy management apparatus communicates with a label printer 2 and a label reading apparatus 4 via the digital multi-functional peripheral 3. In other words, the digital multi-functional peripheral 3 according to the second configuration example illustrated in FIG. 9 is different from the configuration example illustrated in FIG. 1 in that the digital multi-functional peripheral 3 functions not as the proxy management apparatus but as an apparatus that mediates communication between the server 6 as the proxy management apparatus, and the label printer 2 and the label reading apparatus 4.

Here, the label printer 2 and the label reading apparatus 4 can be realized by the same configurations as those described in the above-described first embodiment, and thus detailed description thereof will be omitted. The digital multi-functional peripheral 3 can be realized by the same configuration as that illustrated in FIG. 2 described in the first embodiment, and thus detailed description of its configuration will be omitted. However, it is assumed that the digital multi-functional peripheral 3 communicates with the server 6 via a network interface 36.

Next, a configuration of the server 6 in the authentication information management system 1 according to the second embodiment will be described.

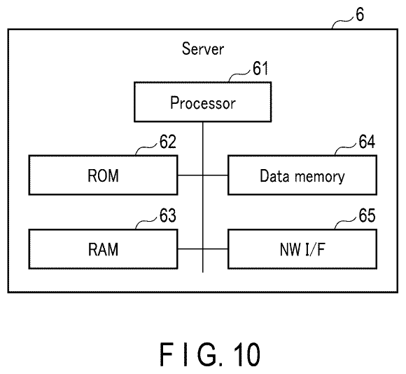

FIG. 10 is a block diagram illustrating a configuration example of the server 6 in the authentication information management system 1 according to the second embodiment.

As illustrated in FIG. 10, the server 6 includes a processor 61, a ROM62, a RAM 63, a data memory 64, an NW interface (I/F) 65, and the like.

The processor 61 executes a program for executing various processing. The processor 61 is, for example, a CPU. The processor 61 is connected to each unit in the server 6 via an internal interface. The processor 61 executes various processing by executing a program stored in the ROM 62 or the data memory 64 using the RAM 63.

The ROM62 is a non-rewritable non-volatile memory. The ROM62 stores a preset program, control data, and the like. The RAM 63 functions as a working memory or a buffer memory.

The data memory 64 is a rewritable non-volatile memory. The data memory 64 stores various data including a program, control data, setting information, and the like.

In addition, the data memory 64 has a storage area for securely storing data. A key data management table KT is provided in the storage area for securely storing data in the data memory 64. The key data management table KT stores key data as authentication information for accessing data stored in the storage device Tg of the label T generated by the label printer 2. The key data management table KT has, for example, a configuration as illustrated in FIG. 4 described above.

The NW interface 65 is a communication interface for performing communication via a network. In the authentication information management system 1, the server 6 communicates with the label printer 2 and the label reading apparatus 4 via the digital multi-functional peripheral 3 communicating via the NW interface 65.

Next, label generation processing including a request for proxy management of key data to the proxy management apparatus by the label printer 2 as an authentication printer according to the second embodiment will be described.

The label printer 2 as the printer according to the second embodiment generates a label by processing similar to the label generation processing illustrated in FIG. 5 described in the first embodiment.

However, in the second embodiment, a processor 51 of the label printer 2 inquires of the digital multi-functional peripheral 3 whether or not the proxy management of the key data by the server 6 as the proxy management apparatus is possible in ACT 12 of FIG. 5. The processor 51 of the label printer 2 transmits a proxy management packet to the digital multi-functional peripheral 3, and receives a notification indicating that the proxy management of the key data by the server 6 has been completed from the digital multi-functional peripheral 3.

As a result, the printer according to the second embodiment can cause the server that is the proxy management apparatus to perform proxy management of the key data as the authentication information via the digital multi-functional peripheral. As a result, the printer according to the second embodiment can generate the label including the storage device in which the information accessible by the authentication information managed by the server is written by the processing described in the first embodiment.

Next, processing in which the digital multi-functional peripheral 3 as the proxy management apparatus according to the second embodiment causes the server 6 to store key data will be described.

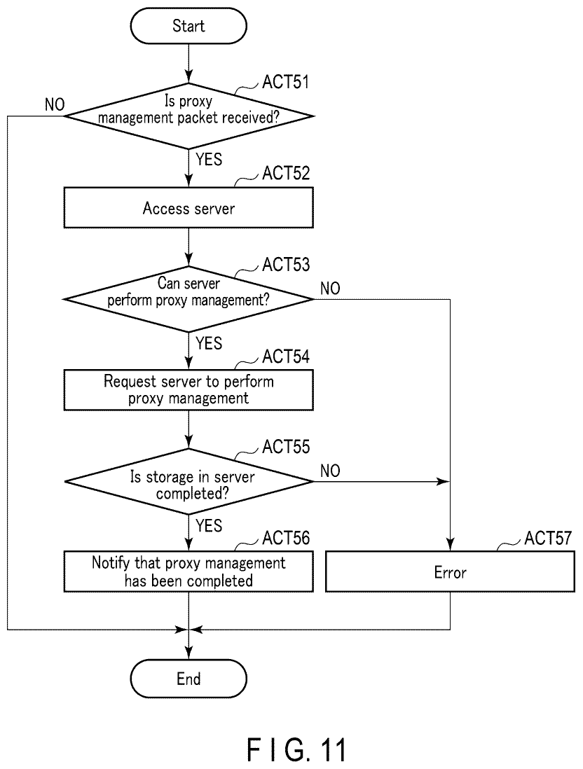

FIG. 11 is a flowchart for explaining an operation example of processing in which the digital multi-functional peripheral 3 as the proxy management apparatus according to the second embodiment causes the server 6 to store key data.

The digital multi-functional peripheral 3 accepts a request for proxy management of key data by the proxy management packet from the label printer 2 as described above (ACT 51).

In a case where the proxy management packet is received from the label printer 2 (ACT 51, YES), a processor 31 of the digital multi-functional peripheral 3 communicates with the server 6 functioning as the proxy management apparatus through the network interface 36 (ACT 52).

Upon establishment of communication with the server 6, the processor 31 of the digital multi-functional peripheral 3 determines whether the server 6 can perform proxy management of key data (ACT 53).

If it is determined that the server 6 cannot perform the proxy management of the key data (ACT 53, NO), the processor 31 of the digital multi-functional peripheral 3 ends the processing as an error (ACT 57). In this case, the processor 31 may transmit a notification indicating that the proxy management of the key data is not possible as a response to the proxy management packet from the label printer 2.

If it is determined that the proxy management by the server 6 is possible (ACT 53, YES), the processor 31 of the digital multi-functional peripheral 3 requests the server 6 to perform the proxy management of the key data (ACT 54). For example, the processor 31 transfers data such as key data for which the proxy management is requested by the proxy management packet from the label printer 2 to the server 6, and requests storage of the data such as the key data in the key data management table KT.

The server 6 functioning as the proxy management apparatus receives, from the digital multi-functional peripheral 3, a request for proxy management as well as data including key data and unique device information that are subjected to the proxy management. The processor 61 of the server 6 stores the key data requested for the proxy management in the key data management table KT in association with the unique device information. In addition, the processor 61 stores not only the key data but also information such as date and time and user setting information in the key data management table KT in association with the unique device information. Upon completion of the storage in the key data management table KT, the processor 61 notifies the digital multi-functional peripheral 3 of completion of the storage.

In a case where a storage completion notification notifying of the completion of the storage of the information such as the key data in the key data management table KT is received from the server 6 (ACT 55, YES), the processor 31 of the digital multi-functional peripheral transmits a notification indicating that the proxy management has been completed to the label printer 2 (ACT 56). For example, the processor 31 transmits, in response to the proxy management packet, the notification indicating that the proxy management has been completed to the label printer 2 that is a transmission source of the proxy management packet.

According to the above processing, upon reception of the proxy management packet from the printer, the digital multi-functional peripheral requests the server as the proxy management apparatus to store the authentication information associated with the unique device information of the printer. As a result, the digital multi-functional peripheral can store the authentication information for accessing information in the storage device of the label in the server having a more robust security function than the label printer. As a result, the information in the storage device of the label can be more securely protected, and unauthorized access to the information in the storage device can be prevented. In addition, since the label printer can request the server to perform proxy management of key data via the digital multi-functional peripheral, the authentication information management system can be easily and inexpensively constructed even if the printer does not have a network communication function or the like.

Next, a first operation example of providing key data managed by the server as the proxy management apparatus according to the second embodiment will be described.

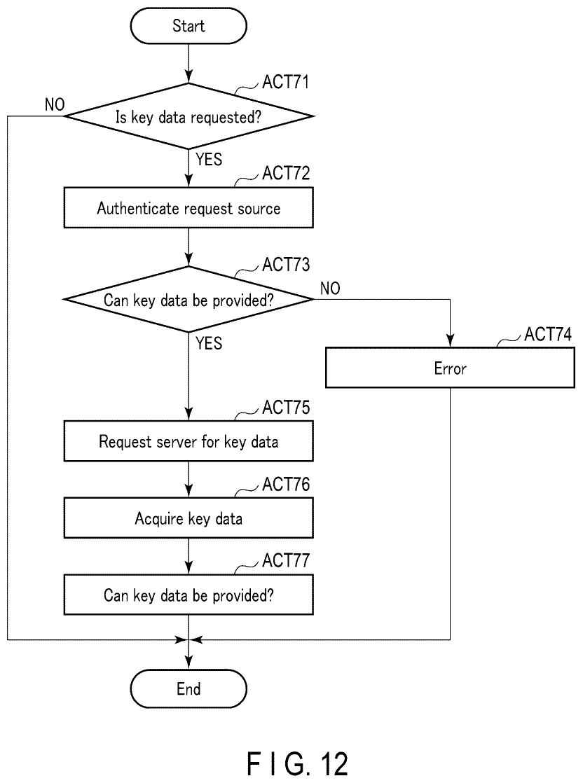

FIG. 12 is a flowchart for explaining a first operation example of provision processing of providing key data managed by the server 6 as the proxy management apparatus according to the second embodiment.

In a case where the key data request is received from the label reading apparatus 4 (ACT 71, YES), the processor 31 of the digital multi-functional peripheral 3 performs processing of authentication that the label reading apparatus 4 is an apparatus that can provide key data (ACT 72). For example, the processor 31 of the digital multi-functional peripheral 3 determines whether or not the label reading apparatus 4 that is a request source of the key data is an apparatus that can provide the key data based on the authentication device information registered in the data memory 34 in advance. In addition, the processor 31 may authenticate the label reading apparatus 4 as an apparatus capable of providing key data by mutual authentication with the label reading apparatus 4.

Further, the digital multi-functional peripheral 3 may authenticate the label reading apparatus 4 as an apparatus capable of providing key data by a code image (two-dimensional barcode) displayed on the display device 42. For example, the processor 31 of the digital multi-functional peripheral 3 displays, on the display device 42, a code image indicating information for allowing provision of key data. The label reading apparatus 4 reads a code image that the digital multi-functional peripheral 3 displays on the display device 42, and accesses the digital multi-functional peripheral 3 by information acquired by reading the code image. The processor 31 of the digital multi-functional peripheral 3 may authenticate the label reading apparatus 4 that has accessed using the information indicating the code image as an apparatus that can provide key data.

In a case where the label reading apparatus 4 that is the request source of the key data cannot be authenticated as an apparatus that can provide the key data (ACT 73, YES), the processor 31 of the digital multi-functional peripheral 3 stops providing the key data as error processing (ACT 74).

In a case where the processor 31 of the digital multi-functional peripheral 3 has been able to authenticate the label reading apparatus 4 that is the request source of the key data as an apparatus capable of providing the key data (ACT 73, YES), the processor allows the provision of the key data to the label reading apparatus 4. Upon allowance of the provision of the key data, the processor 31 requests the server 6 for the key data corresponding to the unique device information specified by the label reading apparatus 4 (ACT 75).

The server 6 receives a provision request for providing key data from the digital multi-functional peripheral 3 via the network interface 65. Upon reception of the provision request for providing key data, the processor 61 of the server 6 reads the key data corresponding to the specified unique device information from the key data management table KT. The processor 61 of the server 6 transfers the read key data to the digital multi-functional peripheral 3 via the network interface 65.

The processor 31 of the digital multi-functional peripheral 3 acquires key data corresponding to the provision request from the server 6 communicating via the network interface 36 (ACT 76). Upon acquiring the key data corresponding to the unique device information specified in the provision request from the server 6, the processor 31 provides the acquired key data to the label reading apparatus 4 as a source of the provision request (ACT 77).

As a result, the label reading apparatus 4 can acquire, from the digital multi-functional peripheral 3, the key data to be managed by the server as the proxy management apparatus in place of the label printer 2 that has generated the label T. The label reading apparatus 4 can read information written in the storage device Tg of the label T using the key data acquired from the digital multi-functional peripheral 3.

Next, a second operation example of the provision processing of providing the key data managed by the server 6 as the proxy management apparatus according to the second embodiment will be described.

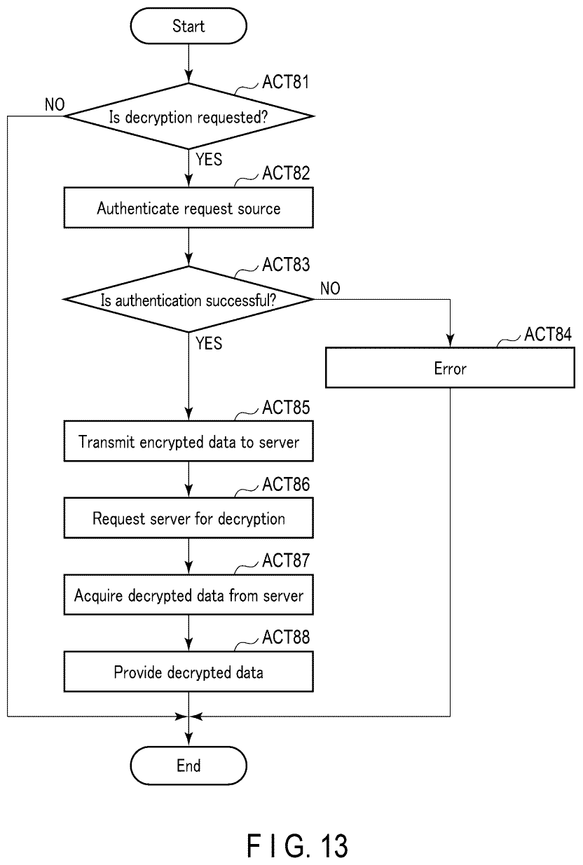

FIG. 13 is a flowchart for explaining a second operation example of the provision processing of providing the key data managed by the server 6 as the proxy management apparatus according to the second embodiment.

In the first operation example, the digital multi-functional peripheral 3 transmits (provides) the key data managed by the server 6 as the proxy management apparatus in response to a request from the label reading apparatus 4. On the other hand, in the second operation example, the digital multi-functional peripheral 3 provides (transmits), to the label reading apparatus 4, data made readable using key data managed by the server 6 as the proxy management apparatus.

In the second operation example, it is assumed that encrypted data that can be decrypted with key data is written as data protected with the key data in the storage device Tg of the label T. The label reading apparatus 4 acquires the encrypted data and the unique device information from the storage device Tg of the label T. The label reading apparatus 4 specifies the unique device information acquired from the storage device Tg and demands (requests) the digital multi-functional peripheral 3 to decrypt the encrypted data.

The processor 31 of the digital multi-functional peripheral 3 communicates with the label reading apparatus 4 through a communication unit such as the communication interface 35 or the network interface 36. The processor 31 accepts a decryption request of the encrypted data that the label reading apparatus 4 has read from the storage device Tg of the label T (ACT 81).

In a case where the decryption request of the encrypted data is received from the label reading apparatus 4 (ACT 81, YES), the processor 31 of the digital multi-functional peripheral 3 performs a processing of authentication that the label reading apparatus 4 is a device capable of providing decryption processing of the encrypted data (ACT 82).

For example, the processor 31 of the digital multi-functional peripheral 3 determines whether or not the label reading apparatus 4 that is a source of the decryption request is an apparatus that can provide decryption processing of data based on authentication device information registered in the data memory 34 in advance. In addition, the processor 31 may authenticate the label reading apparatus 4 as an apparatus capable of providing decryption processing of data by mutual authentication with the label reading apparatus 4.

Further, the digital multi-functional peripheral 3 may authenticate the label reading apparatus 4 as an apparatus capable of providing decryption processing of data by a code image (two-dimensional barcode) displayed on the display device 42. For example, the processor 31 of the digital multi-functional peripheral 3 displays, on the display device 42, a code image indicating information for allowing provision of the decryption processing of data. The label reading apparatus 4 reads a code image that the digital multi-functional peripheral 3 displays on the display device 42, and accesses the digital multi-functional peripheral 3 by information read from the code image. The processor 31 of the digital multi-functional peripheral 3 may authenticate the label reading apparatus 4 accessed by the information indicating the code image as an apparatus that can provide decryption processing of data.

The processor 31 of the digital multi-functional peripheral 3 determines whether or not to allow provision of the decryption processing for the encrypted data depending on whether or not the label reading apparatus 4 as the source of the decryption request has been authenticated (ACT 83). In a case where the processor 31 cannot provide the decryption processing of the encrypted data (ACT 83, NO), the processor performs error processing and ends the processing (ACT 84).

In a case where the provision of the decryption processing of the encrypted data is allowed (ACT 83, YES), the processor 31 of the digital multi-functional peripheral 3 transmits the encrypted data (ACT 85) and requests for decryption of the encrypted data by specifying the unique device information (ACT 86).

The server 6 receives the encrypted data and the request for decryption of the encrypted data from the digital multi-functional peripheral 3 via the network interface 65. Upon reception of the request to decrypt the encrypted data, the processor 61 of the server 6 reads the key data corresponding to the specified unique device information from the key data management table KT.

The processor 61 of the server 6 decrypts the encrypted data received together with the decryption request from the digital multi-functional peripheral 3 using the key information for decryption included in the read key data. Upon decryption of the encrypted data using the key data, the processor 61 transfers the decrypted data to the digital multi-functional peripheral 3 via the network interface 65.

The processor 31 of the digital multi-functional peripheral 3 acquires the decrypted data obtained by decrypting the encrypted data with the key data from the server 6 communicating via the network interface 36 (ACT 87). Upon acquisition of the decrypted data from the server 6, the processor 31 provides the acquired decrypted data to the label reading apparatus 4 which is the source of the decryption request (ACT 88).

As a result, the label reading apparatus 4 can acquire, from the digital multi-functional peripheral, data obtained by decrypting the encrypted data in the storage device Tg using key data subjected to proxy management by the server 6 as the proxy management apparatus. That is, the label reading apparatus can acquire data obtained by decrypting the encrypted data without executing the decryption processing of the encrypted data in the storage device Tg. As a result, the label reading apparatus can read encrypted data in the storage device without performing complicated arithmetic processing such as decryption. In addition, since the entire authentication information management system can read the encrypted data with the label reading apparatus without outputting the key data to the outside of the server as the proxy management apparatus, the effect of preventing leakage of the key data and the like is high and robust security can be provided.

### THIRD EMBODIMENT

Next, an authentication information management system 1 according to a third embodiment will be described.

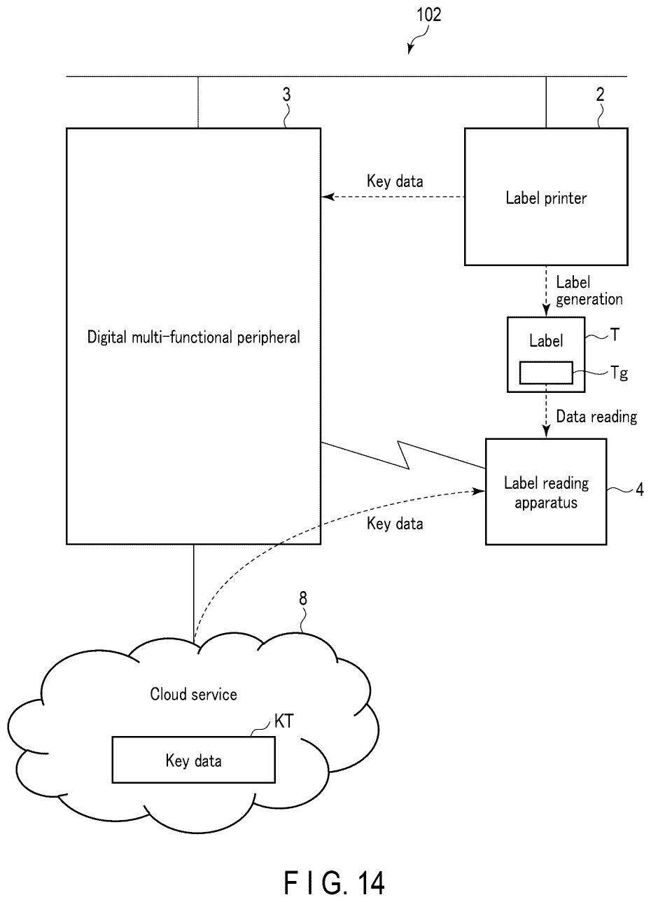

FIG. 14 is a diagram illustrating a configuration example of the authentication information management system 1 according to the third embodiment. The authentication information management system 1 according to the third embodiment illustrated in FIG. 14 is configured such that a server 6 in the second embodiment is provided as a cloud service 7. Therefore, it is assumed that a digital multi-functional peripheral 3 according to the third configuration example illustrated in FIG. 14 communicates with the server of the cloud service 7 via a network interface 36. The server in the cloud service 7 has a key data management table KT as described in the first and second embodiments, and functions as a proxy management apparatus that manages key data.

That is, the authentication information management system 1 according to the third embodiment has a configuration in which the server of the cloud service 7 functioning as the proxy management apparatus communicates with a label printer 2 and a label reading apparatus 4 via the digital multi-functional peripheral 3. In other words, in the configuration of the authentication information management system 1 of the third embodiment illustrated in FIG. 14, the server 6 in the configuration of the authentication information management system according to the second embodiment illustrated in FIG. 9 is replaced with the cloud service 7. The authentication information management system 1 according to the third embodiment can be realized by a configuration in which the server 6 in the second embodiment is replaced with the cloud service 7, and thus detailed description thereof will be omitted.

In the embodiment described above, the memory 52 of the label printer 2 is a non-transitory tangible computer readable storage medium that stores a program for a processor 51 to execute processing or control in the label printer 2 described above. Furthermore, a ROM 32 or a data memory 34 of the digital multi-functional peripheral 3 is a non-transitory tangible computer readable storage medium that stores a program for a processor 31 to execute processing or control in the digital multi-functional peripheral 3 described above. Furthermore, a ROM 62 or a data memory 64 of the server 6 is a non-transitory tangible computer readable storage medium that stores a program for the processor 31 to execute processing or control in the server 6 described above.

These programs may be individually delivered and written in the respective devices according to an operation of an administrator or the like. Furthermore, each of the programs may be stored in a removable non-transitory tangible computer readable storage medium and delivered, or may be delivered by communication via a network. The non-transitory tangible computer readable storage medium may be a storage device such as an optical disk, a memory card.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. A printer comprising:
a communication unit that communicates with an external device;
a printing unit that prints an image on a medium including a storage device in which data is allowed to be stored;
a reader/writer that writes data in the storage device included in the medium on which the printing unit prints the image; and
a processor that requests a proxy management apparatus to manage authentication information for accessing the data written in the storage device by the reader/writer, the proxy management apparatus being connected to the communication unit.

2. The printer according to claim 1, wherein
the processor transmits a proxy management packet for requesting the proxy management apparatus to manage the authentication information by the communication unit, and writes data protected by the authentication information in the storage device by the reader/writer after a storage completion notification of the authentication information is received from the proxy management apparatus.

3. The printer according to claim 1, further comprising:
a memory that stores authentication device information indicating the proxy management apparatus, wherein
the processor creates a dedicated proxy management packet to be transmitted to the proxy management apparatus indicated by the authentication device information.

4. The printer according to claim 1, wherein
the authentication information is key information for decrypting encrypted data to be written in the storage device.

5. The printer according to claim 1, wherein
the authentication information is a password.

6. A proxy management apparatus comprising:
a communication unit that communicates with a printer including a printing unit and a reader/writer, the printing unit printing an image on a medium, the reader/writer writing data in a storage device included in the medium;
a memory having a storage area in which data is securely stored; and
a processor that, upon reception of a request to manage authentication information for accessing data written in the storage device included in the medium by the communication unit from the printer, stores the authentication information in the memory in association with identification information of the printer.

7. The proxy management apparatus according to claim 6, wherein
upon reception of a proxy management packet requesting to manage the authentication information from the printer, the processor stores the authentication information in the memory in association with the identification information of the printer according to the proxy management packet, and then transmits a storage completion notification to the printer.

8. The proxy management apparatus according to claim 6, further comprising:
a memory that stores authentication device information indicating the printer, wherein
the processor accepts a proxy management packet from the printer indicated by the authentication device information.

9. The proxy management apparatus according to claim 6, wherein
the communication unit includes an interface that communicates with a reading apparatus that reads information from the storage device included in the medium, and
the processor supplies the authentication information corresponding to the identification information of the printer stored in the memory to the reading apparatus in response to a request from the reading apparatus for the authentication information specifying the identification information of the printer.

10. The proxy management apparatus according to claim 9, wherein
the processor performs mutual authentication with the reading apparatus, and supplies the authentication information in response to a request from the reading apparatus with which the mutual authentication is successful.

11. The proxy management apparatus according to claim 6, wherein
the communication unit includes an interface that communicates with a reading apparatus that reads information from the storage device included in the medium, and
upon reception of encrypted data read from the storage device together with the identification information of the printer from the reading apparatus communicating by the communication unit, the processor supplies data obtained by decrypting the encrypted data with key information included in authentication information corresponding to the identification information of the printer to the reading apparatus.

12. The proxy management apparatus according to claim 11, wherein
the processor performs mutual authentication with the reading apparatus, and performs decryption of the encrypted data in response to a request from the reading apparatus with which the mutual authentication is successful.

13. The proxy management apparatus according to claim 6, wherein
the proxy management apparatus is a digital multi-functional peripheral.

14. The proxy management apparatus according to claim 6, wherein
the proxy management apparatus is a server that communicates with the printer via a digital multi-functional peripheral.

15. An authentication information management system comprising:
a printer; and
a proxy management apparatus, wherein the printer includes:
a first communication unit that communicates with the proxy management apparatus;
a printing unit that prints an image on a medium including a storage device in which data is allowed to be stored;
a reader/writer that writes data in the storage device included in the medium on which the printing unit prints the image; and
a first processor that requests a proxy management apparatus to manage authentication information for accessing the data written in the storage device by the reader/writer, the proxy management apparatus being connected to the communication unit, and
the proxy management apparatus includes:
a second communication unit that communicates with the printer;
a memory having a storage area in which data is securely stored; and
a second processor that, upon reception of a request to manage authentication information for accessing data written in the storage device included in the medium by the communication unit from the printer, stores the authentication information in the memory in association with identification information of the printer.

16. The authentication information management system according to claim 15, wherein
the proxy management apparatus is a digital multi-functional peripheral.

17. The authentication information management system according to claim 15, wherein
the proxy management apparatus is a server that communicates with the printer via a digital multi-functional peripheral.

18. The authentication information management system according to claim 15, wherein
the first processor of the printer transmits a proxy management packet for requesting the proxy management apparatus to manage the authentication information by the first communication unit, and writes data protected by the authentication information in the storage device by the reader/writer after a storage completion notification of the authentication information is received from the proxy management apparatus, and
upon reception of the proxy management packet from the printer by the second communication unit, the second processor of the proxy management apparatus stores the authentication information in the memory in association with the identification information of the printer, and transmits a storage completion notification to the printer upon completion of the storage of the authentication information in the memory.

19. The authentication information management system according to claim 15, wherein
the second communication unit of the proxy management apparatus includes an interface that communicates with a reading apparatus that reads information from the storage device included in the medium, and
in response to a request from the reading apparatus for authentication information specifying the identification information of the printer, the second processor of the proxy management apparatus supplies the authentication information corresponding to the identification information of the printer stored in the memory to the reading apparatus.

20. The authentication information management system according to claim 15, wherein
the second communication unit of the proxy management apparatus includes an interface that communicates with a reading apparatus that reads information from the storage device included in the medium, and
upon reception of encrypted data read from the storage device together with the identification information of the printer from the reading apparatus, the second processor of the proxy management apparatus supplies data obtained by decrypting the encrypted data with key information included in authentication information corresponding to the identification information of the printer to the reading apparatus.
